(19) United States
(12) Patent Application Publication
(10) Pub. No.: US 2010/0228466 A1
(43) Pub. Date: Sep. 9, 2010

(54) INTERNAL COMBUSTION ENGINE OPERATIONAL SYSTEMS AND METH0DS

(75) Inventors: Jack A. EKCHIAN, BELMONT, MA (US); Berj A. TERZIAN, Newbury, MA (US)

Correspondence Address: LUCAS & MERCANTI, LLP, 475 PARK AVENUE SOUTH, 15TH FLOOR, NEW YORK, NY, 10016, US

(73) Assignee: TRITEL, LLC, Newbury, MA (US)

(21) Appl. No.: 12/544,675

(22) Filed: Aug. 20, 2009

Related U.S. Application Data
(60) Provisional application No. 61/157,456, filed on Mar. 4, 2009.

(51) Int. Cl. F02D 41/06; F02M 51/00; F02P 5/00; F01L 1/34

(52) U.S. Cl. 701/113; 123/491; 123/406.76; 123/90.15

(57) ABSTRACT

An internal combustion engine in which intake and exhaust valve timing is varied to improve cold-start performance and emissions and to increase cylinder-out temperatures under certain operating conditions. Valve timing is controlled to modify in-cylinder conditions to enhance certain physical and chemical processes. Valve timing is preferably determined based on measurement and calculation of engine operating parameters.

### CROSS REFERENCE TO RELATED APPLICATIONS

This Application claims the priority of U.S. Provisional Patent Application No. 61/157,456 filed Mar. 4, 2009 the entire contents of which is hereby incorporated by reference.

### BACKGROUND OF THE INVENTION

1. Field of the Invention

This invention relates to the improved performance and reduced emissions from internal combustion (IC) engines during cold temperature, and light and moderate load operation. It involves increasing the time available for in-cylinder physical and chemical processes under certain conditions, increasing the rates of these processes and increasing cylinder-out temperatures to improve performance of exhaust emission control devices.

2. Description of Prior Art

IC engines convert fuel chemical energy into useful mechanical energy. They have long been recognized as low cost, flexible, and robust power-plants for a broad spectrum of applications. Over the past 25 years, automotive scientists and engineers worldwide have made major advances in the use of IC engines for transportation.

In IC engines, fuel and air are mixed, and ignited and allowed to burn in a combustion chamber in a cylinder. The resulting elevated as pressure causes a piston located within the cylinder to move. The linear motion of the piston is typically convened to rotary motion of the engine output shaft by means of a slider crank mechanism although other mechanisms, such as a Scotch Yoke, may be utilized. The products of combustion are subsequently discharged from the cylinder and the cycle is repeated.

Most IC engines manufactured today use cycles that comprise four strokes or processes: 1) the intake stroke where air or an air-fuel mixture is admitted into the engine cylinder via one or more intake valves, 2) the compression stroke where the engine cylinder is sealed and the air or air-fuel mixture is compressed as a result of the motion of a piston, 3) the power or expansion stroke where an air-fuel mixture is burned and the high pressure resulting from the combustion acts to move the piston and to produce work, and 4) the exhaust stroke where the products of combustion are expelled from the cylinder via at least one open exhaust valve.

Most IC engine powerplants in use today are either spark ignition (SI) engines or compression ignition (CI) engines. In conventional SI (CSI) engines, fuel is typically added to air outside the cylinder and the resulting fuel-air mixture is ignited with a spark plug after being compressed in the cylinder. In CI engines, fuel is typically injected into the compression heated air in the cylinder late in the compression process which then spontaneously auto-ignites. CI engines operate primarily with a lean overall air-fuel ratio, while CSI engines typically utilize a stoichiometric air-fuel mixture. In some SI engines, at least some of the fuel is injected into the cylinder. Such injection spark ignition (ISI) engines, where fuel is injected into the cylinder, may operate with a lean or stoichiometric overall air-fuel ratio. In some IC engines, exhaust gas recirculation (EGR), where some of the exhaust gas is returned to the intake, is used to reduce certain emissions.

Present day transportation IC engines exhibit very high combustion efficiency and produce exceptionally low pollution levels during normal operating conditions. Combustion efficiency is the fraction of the fuel energy supplied to an engine cylinder that is released by combustion. Under normal operating conditions, combustion efficiency is typically in excess of 98%. However, in certain situations, IC engines suffer from poor combustion, high emissions and degraded performance. For example, during start-up, especially when the engine is cold (cold-start), both SI and CI engines are susceptible to erratic operation, such as misfire, and high emissions. Under such conditions, combustion efficiency can be as low as zero. Also, during operation at light and moderate loads, even fully warmed up engines, that operate with leaner than stoichiometric air-fuel ratios, suffer from relatively cool exhaust. This is problematic when emission control equipment, such as particulate traps, are used. Such devices require periodically elevated exhaust gas temperatures to operate properly.

Under normal circumstances, the fuel and air charge in CSI engines is well mixed by the time ignition occurs. It is a stoichiometric, combustible mixture with very few, if any, rich or lean pockets. Ignition typically occurs as the piston approaches the end of the compression stroke commonly called the top center (TC) position. Common fuels used in CSI engines include gasoline, alcohol, and alcohol-gasoline blends. Recently there has been increasing interest in the use of natural gas and even hydrogen.

During the last few decades there has been a dramatic reduction in tail pipe emission of unburned hydrocarbons (HC), carbon monoxide (CO) and oxides of nitrogen (NOx) from vehicles powered with CSI engines. Key to this reduction has been the development, use and continued improvement of the three-way catalytic converter (TWC). The TWC has proven to be exceptionally effective under most operating conditions. It is external to the engine and acts on the exhaust gases after they leave the cylinder through the exhaust valve. When the TWC reaches normal operating temperature, it is capable of removing substantially all of the HC, CO & NOx pollutants produced by the SI engine so long as the engine is operated at a stoichiometric overall air-fuel ratio.

However, the TWC is ineffective at low temperatures, such as during cold-start. Under these conditions, the TWC does not appreciably reduce cylinder-out emissions before they leave the exhaust pipe. Therefore, whatever is produced in the cylinder largely escapes into the atmosphere. As a result, the bulk of HC and CO emissions from an SI engine powered vehicle with a TWC are typically produced during approximately the first 60 seconds of operation. This is largely because it takes approximately 60 seconds for the TWC to reach operational temperatures. Various types of auxiliary catalyst heaters have been tested in the laboratory to accelerate this warm-up process, but have not achieved widespread use due to drawbacks such as high cost, excessive electrical load and adverse fuel economy impact.

When the engine is cold, not only is the TWC ineffective, but the chemical processes in the cylinder are also sub-optimal and produce high amounts of emissions. Typically, the time available for evaporation and mixing before ignition must occur in SI engines is very limited. At cold temperatures, slower evaporation rates hamper proper mixture formation in the cylinder. As a result, even if the overall fuel and air mixture supplied to an engine is stoichiometric, the mixture can become stratified so that very lean and very rich pockets are produced. Such lean pockets are typically difficult to ignite. If a lean pocket happens to be located in the region of the spark plug at the time it discharges, misfire may result. Even if the mixture is successfully ignited, the temperature and local stoichiometry in the vicinity of the ignition site may be such that the flame cannot be sustained, still resulting in partial or complete misfire.

Misfire frequently leads to high concentrations of HC or CO in the exhaust, excessive cyclic engine torque variability and a cool exhaust temperature. To reduce the likelihood of such problems, engine designers frequently resort to over-fueling the engine during cold-start. The overall equivalence ratio of the mixture is made richer which reduces the chances of misfire and reduces cyclic variability. However, the richer overall stoichiometry exacerbates the HC and CO emissions. Consequently, large amounts of unburned or partially burned fuel are expelled from the cylinder during the exhaust process under such conditions. Poorly combusted mixtures are necessarily cooler. The problem is therefore compounded by the fact that the high emissions cannot be eliminated by the cold TWC. This results in a vicious cycle where the TWC in turn is not warmed up quickly because of the cool exhaust temperatures.

In 4-cycle injection engines such as CI and ISI engines, the bulk of the fuel is typically injected into the cylinder during the intake or compression strokes although some fuel may be added to the air before it is inducted into the cylinder. In some injection engines, fuel is injected into a separate chamber, called a pre-chamber, that is in communication with the cylinder. The fuel injection into the cylinder occurs during the intake or compression processes in the form of a single or multiple injection pulses. Under normal operating conditions, the fuel rapidly atomizes, evaporates and mixes with the gases in the cylinder. In CI engines the mixture typically auto-ignites without the intervention of a spark device when it is injected into the compression heated gases in the cylinder. CI engines typically use diesel fuel and operate under leaner than stoichiometric overall equivalence ratios at all times. In ISI engines, a spark source is typically used and the engines may operate under overall lean or stoichiometric conditions.

Ignition in IC engines may occur by means other than a spark plug, such as homogeneous charge compression ignition (HCCI). HCCI is an ignition process whereby an air-fuel charge is allowed to simultaneously auto-ignite throughout the entire combustion chamber. Examples of an HCCI implementation are disclosed in U.S. Pat. Nos. 5,535,716, 7,343,902 and 7,461,627 that are incorporated herein by reference in their entirety.

TWC's are typically lot used with IC engines that operate primarily at other than stoichiometric conditions. However, cold-start is a problem in lean operating injection engines, such as CI and ISI engines, as well. As in CSI engines, start up under cold ambient conditions in injection engines can lead to partial or total misfire due to poor fuel evaporation, mixing, ignition and combustion. As a result, rough operation and excessive emissions may result. In CI engines, these difficulties can sometimes be diminished but not eliminated by the use of glow plugs.

Because CI and lean ISI engines operate with excess air, the exhaust from even a warmed up engine may be relatively cool. This dilution, which results in depressed exhaust temperatures especially at light and moderate operating conditions, makes it difficult to operate some exhaust treatment devices. Devices such as particulate traps, that must be used to control soot emissions, rely on heat from the exhaust for regeneration. Circulating large quantities of excess air through the system also results in additional pumping losses and fouling of engine components such as filters.

This invention ameliorates these limitations of IC engines during certain operating conditions in an effective manner without disturbing their performance under normal operating conditions.

### SUMMARY OF INVENTION

It is a primary object of this invention to improve the performance of IC engines under certain operating conditions where cold engine temperatures result in poor combustion, high emissions and low cylinder-out temperatures. Cylinder-out temperature is the mean temperature of the gas leaving the cylinder through an exhaust valve. This mean is determined by mass averaging the instantaneous exhaust temperature over the period that the valve is open. Improved performance is achieved by extending the time available for in-cylinder processes such as evaporation, mixing and combustion. The increase in time available is achieved by modifying conventional 4-stroke valve timing to include additional expansion and compression strokes between an intake stroke and any subsequent discharge of mass from the cylinder, such as a result of an exhaust stroke.

It is a further object of this invention to have at least one fuel injection event in each of at least two compression strokes in a lean injection engine, such as CI and lean ISI, which occur between an intake stroke and any subsequent discharge of mass from the cylinder. Any combustion products generated as a result of an earlier fuel injection event are retained to increase the temperature of the gas in the cylinder and accelerate physical and chemical processes during subsequent compression and expansions strokes.

It is a further object of this invention to have at least one fuel injection event in an injection engine during one compression or one expansion stroke where at least some of the combustion of the resulting fuel and air mixture occurs during a subsequent compression or expansion stroke and before cylinder contents are discharged from the cylinder.

It is a further object of this invention to expose liquid fuel in an IC engine cylinder to lowered cylinder pressures after fuel delivery to the cylinder to induce liquid fuel break up by means of bubble formation in the liquid fuel.

It is a further object of this invention to increase the cylinder-out temperature of a CI or lean ISI engine during light and moderate load operation.

It is a further object of this invention to increase the cylinder-out temperature from an IC engine cylinder before the engine has reached operating temperature such as during cold start.

It is a further object of this invention to reduce cylinder out emissions from CSI engines during certain operating conditions, such as cold start, where the engine is cold.

It is a further object of this invention to open cylinder valves in an IC engine late during the intake stroke or early during the compression stroke if the pressure in the cylinder is low compared to the pressure upstream of the valves, causing a rush of incoming gases to supplement the mass in the cylinder or enhance mixing within the cylinder.

It is a further object of this invention to enhance the regeneration of particulate traps by increasing cylinder-out temperatures at low and moderate loads in lean engines.

In today's CSI engines that use liquid fuel, the fuel is typically added to the air outside a cylinder at a point just upstream of the intake valve. Either before or after entering the cylinder through one or more valves, the fuel must evaporate and thoroughly mix with the air prior to ignition. These processes must occur very quickly, typically within 0.2 seconds or less. When the engine is cold, such as during cold start, the rate of evaporation is slowed. As a result, a substantial fraction of the fuel supplied to a cylinder can survive in liquid form in the cylinder until ignition or later. Fuel in liquid form cannot be effectively mixed with air to produce an ignitable or combustible mixture and may therefore leave the cylinder during exhaust without burning.

Under cold operating conditions, chemical reaction rates are also diminished such that even fuel that has vaporized may not ignite properly. Even fuel that is successfully vaporized and ignited may fail to burn completely in a timely fashion. Under such conditions, if the exhaust valves are opened with a conventional 4-stroke cycle timing, a substantial quantity of unburned or partially burned fuel may be expelled from the cylinder. Such exhaust gases would also not attain an elevated temperature since a substantial portion of the heating value of the fuel would not have been released. Therefore, even if the engine is fitted with a TWC, under these conditions such emissions would not be effectively eliminated because of the poor performance of an unheated converter.

According to one embodiment of this invention, the intake and exhaust valves of an IC engine cylinder are timed to retain any unburned or partially burned mixture for additional compression and expansion strokes so that they may be fully burned prior to being expelled from the cylinder. Furthermore, heat released during earlier strokes is used to accelerate physical and chemical processes during subsequent strokes.

According to a further embodiment of the invention, the valves of an IC engine are timed to expose liquid fuel in the cylinder to lowered pressures to facilitate liquid fuel break up. According to the invention, the intake valves are opened and fuel and air are inducted into a cylinder where at least a portion of the fuel may be in liquid form. The intake valve or valves are then closed to seal the cylinder substantially before the piston reaches the bottom center (BC) position, so that the pressure in the cylinder drops. The earlier the valve is closed, the lower the pressure that will be achieved. The lower pressure will cause certain low boiling point portions of the fuel or dissolved air in the fuel to rapidly form bubbles. This will help break apart the liquid fuel droplets or film and the resulting smaller droplets will evaporate more readily. If necessary, at least one intake valve or exhaust valve may subsequently be opened to allow additional air or air-fuel mixture to rush into the cylinder either before or after the piston reaches the BC position. The resulting rush of gas into the cylinder may also help mix the air and the fuel within the cylinder and improve the uniformity of the mixture in the cylinder.

Late in the compression process or early in the expansion process of the SI engine, the ignition source is triggered to ignite the air-fuel mixture. The mixture may also be ignited by other means such as HCCI.

Under certain circumstances, ignition and subsequent combustion may be ineffective or partially effective leaving a substantial amount of unburned or partially burned fuel in the cylinder. Opening the exhaust valve under such condition will result in a high level of emissions being expelled from the engine. When the piston approaches the position where the exhaust valves may normally be opened in a conventional 4-stroke cycle or at any convenient point after ignition, engine or cylinder sensors may be used by onboard processors to determine the burned fraction of the mixture in the cylinder and whether the extending the cycle may be beneficial. If it is determined not to extend the cycle, the exhaust valves may be opened to discharge the contents of the cylinder. Sensors that can be used to evaluate the state of the mixture in the cylinder include pressure, luminosity, temperature, and oxygen sensors, or crankshaft acceleration detectors. Look up tables may also be used to estimate the fraction of burned mass based on engine operating and ambient conditions. The engine cylinder may then be returned to conventional 4-stroke operation for subsequent cycles. This decision may be independent of whether or not the other cylinders of a multi-cylinder engine are returned to conventional operation.

If the exhaust valve is not opened, the mixture in the cylinder will undergo an additional compression process. The temperature of the mixture in the cylinder during subsequent compressions may be higher due to retained heat from oxidation of fuel up to that point in the cycle. When the piston again approaches its TC position, the ignition source may again be triggered to ignite any still unburned fuel mixture. Any remaining fuel may also be ignited by an alternative ignition mechanism, such as HCCI.

Subsequently as the piston again approaches the end of the expansion stroke, a decision may again be made whether or not to open the exhaust valves. Alternatively if it is determined that the pressure in the cylinder is lower than the pressure upstream of the intake valve, the intake valve may be opened again to admit additional air or air and fuel,

Under warmed up operating conditions, the cylinders of a CSI engine with a TWC are normally supplied with stoichiometric mixture so that any pollutants that leave the cylinder can effectively be eliminated. However, to avoid erratic operation and misfire during cold start, CSI engines are frequently over-fueled with a fuel rich mixture. This promotes more reliable ignition and combustion events, but unfortunately results in high levels of HC and CO emissions and higher fuel consumption. In a CSI engine designed according to this invention, since the fuel, even during cold-start, can be effectively evaporated, mixed and combusted within the cylinder, over fueling is thus not necessary. The cylinder may be operated during cold-start with a stoichiometric or lean mixture. The total amount of fuel-air mixture inducted into the cylinder and thus the power produced during a cycle may be controlled by timing the opening and closing of the intake valves based on the average load requirements at a given time and the length of the cycle.

According to a further embodiment of the invention, the intake and exhaust valves of injection engines, such as a CI or lean ISI engine, may be timed to increase utilization of air inducted into a cylinder of the engine and to increase the mean cylinder-out temperature. Air may be inducted into the cylinder of an injection engine through an open valve as the piston moves toward the BC position. The intake valve may be closed early, thus creating a vacuum in the cylinder whenever the cylinder volume is near its maximum. If the liquid fuel injected into the cylinder does not evaporate and burn completely, the pressure in the cylinder may be allowed to drop to form a vacuum as the piston moves to the BC position. The drop in pressure would cause dissolved air or high volatility portions of any remaining liquid fuel to form bubbles, thus accelerating evaporation by helping to break up fuel still in liquid form. The engine valves may be reopened if the cylinder pressure is sufficiently depressed so that additional mass may be inducted into the cylinder.

As the piston the proceeds through another compression process, the trapped mixture in the cylinder is again compressed resulting in increased pressure and temperature. If up to this point any amount of fuel has reacted with the air, the heat released and retained will augment the beating effect of the compression. Additional fuel may then be injected into the cylinder, preferably during the compression process. The fuel in such a subsequent injection may evaporate, mix and burn more rapidly because of the increased temperatures. The subsequent combustion and expansion may be followed by additional compression strokes and additional injections so long as sufficient un-reacted oxygen is available in the cylinder to satisfactorily mix and burn any additional fuel. At any time during a cycle, but preferably at a convenient point during an expansion stroke, a decision may be made based on the state of the mixture in the cylinder to open the exhaust valve and expel the products of combustion and to begin a new cycle.

The total amount of fuel injected into the cylinder during any cycle will be a function of the load requirements at a given operating condition. With multiple injections, the overall equivalence ratio in the cylinder may be increased at a given engine load such that average air usage will be lower. Consequently, the cylinder-out temperatures will be higher than if a conventional 4-stroke cycle was utilized for the same engine load. These higher exhaust temperatures will facilitate the regeneration of exhaust treatment devices, such as particulate traps.

The intake and exhaust valves of this invention may be opened and closed by variable timing mechanisms. Examples of such mechanisms are disclosed in U.S. Pat. Nos. 5,327,856; 6,532,2919; 6,568,359; 6,857,404; 7,444,969; 7,448,350; that are incorporated herein by reference in their entirety. Under certain conditions the differential pressure between the cylinder and the manifold may also be controlled to cause one or more valves to float open. Manifold boost mechanisms, such as turbochargers or super chargers, may be used to increase intake manifold pressures.

It is preferred that one or more engine operating parameters at one or more points during an engine cycle be measured. Parameters that may be measured include, for example, cylinder pressure, instantaneous torque, and fuel and air flow into the cylinder. Based on these measurements, quantities such as fraction of mass burned in the cylinder may be determined. It is further preferred that, based on such measurements and calculations, quantities such as intake or exhaust valve timing, amount or timing of fuel delivery or ignition timing be established. Types of devices that may be used to collect such information include air mass flow sensors, manifold pressure and temperature sensors, cylinder pressure and temperature sensors, engine shaft instantaneous acceleration or torque sensors, or in-cylinder flame detection sensors such as ionization sensors. Description of several such sensors and their use for engine monitoring and control are discussed in U.S. Pat. Nos. 5,337,240; 5,775,299; 5,777,216; 7,111,611; 7,472,600 and 7,529,637 which are incorporated herein by reference in their entirety. Examples of using cylinder pressure as an engine control parameter are disclosed in U.S. Pat. Nos. 4,624,229; 6,560,526; 7,290,442; and 7,440,841 that are incorporated herein by reference in their entirety. Sensors may be used individually or in sensor suits of two or more. Parameters may also be estimated based on engine data pre-stored in a look-up table.

In U.S. Pat. No. 7,418,928, Fiveland discloses an engine which utilizes an extended cycle. In this engine, a dedicated valve is utilized to relieve excess pressure. Such a valve would make the cylinder head more complex and more expensive to manufacture. Such a valve would also be very difficult to fit into a cylinder head of a modern engine because of extremely limited space. In the current invention, over pressure problems described by Fiveland would be avoided by properly metering the fuel and the air inducted. Furthermore, removing the hot gases from the cylinder during a cycle would be contrary to the intent of this invention.

### BRIEF DESCRIPTION OF THE DRAWINGS

FIG. 1 shows the schematic of an SI engine cylinder with spark plug, port fuel injection and in-cylinder sensor. Also shown are variable controllers for intake and exhaust valves.

FIG. 2 shows an injection engine cylinder with an in-cylinder injector and sensor and a cupped piston. Also shown are variable controllers for intake and exhaust valves.

FIG. 3 shows a schematic of an engine control system.

FIG. 4 shows the schematic of a 6-cylinder IC engine and portions of its intake and exhaust systems.

FIG. 5 shows an SI engine cylinder undergoing a conventional 4-stroke cycle.

FIG. 6 is a schematic showing cylinder volume fluctuation as a function of time and intake and exhaust valve open periods for 3 consecutive conventional 4-stroke cycles.

FIG. 7 shows a schematic SI engine cylinder undergoing an expanded cycle that includes cylinder pressure depression to enhance liquid fuel break up.

FIG. 8 is a schematic showing cylinder volume fluctuation as a function of time and valve timing for an engine undergoing 3 consecutive 4-stroke cycles where valves as timed to depress pressure in the cylinder during intake process.

FIG. 9 is a schematic showing cylinder volume fluctuation as a function of time of the pressure and valve timing for expanded and conventional cycles of all IC engine.

FIG. 10 is a schematic of an injection engine cylinder undergoing an expanded cycle that includes cylinder pressure depression.

FIG. 11 is a schematic showing cylinder volume fluctuation as a function of time and valve timing and injection timing for expanded and conventional cycles of an injection engine.

### DETAILED DESCRIPTION OF THE INVENTION

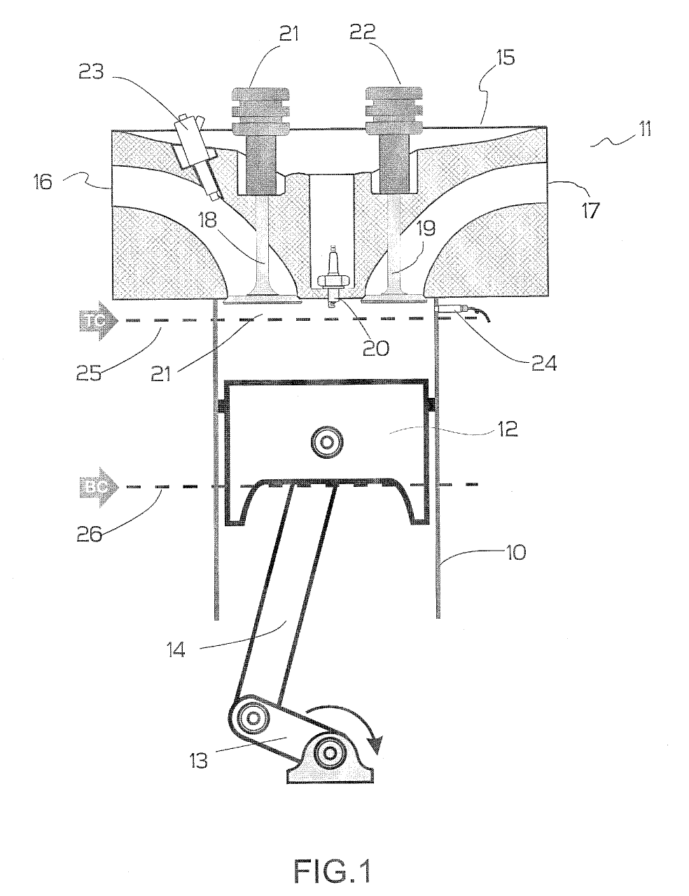

FIG. 1, a schematic of an embodiment of the invention, shows a cylinder 10 of an SI engine 11 which may have one or more cylinders. Slidably fitted within the cylinder is a piston 12 which is connected to a crank 13, located at one end of the cylinder, by means of a connecting rod 14. The other end of the cylinder is sealed by means of a cylinder head 15. The cylinder head comprises intake port 16 and exhaust port 17. The cylinder head also comprises at least one intake valve 18 and at least one exhaust valve 19. Each cylinder has at least one spark plug 20 that can be used to ignite the mixture in the combustion chamber 21. Other means of ignition such as, for example, HCCI may also be utilized instead of or in conjunction with the spark plug.

The intake and exhaust valves are opened with proper timing by means of variable valve actuating mechanisms 21 and 22 respectively. The actuating mechanisms may be driven electrically, hydraulically, pneumatically or mechanically or with a combination of two or more of these methods. They may control the timing or the amount of the opening of the valves.

In this embodiment, fuel is added to the air by means of a fuel injector 23 located upstream and in close proximity to the intake valve. Fuel is then carried into the cylinder with the air through an open intake valve. Fuel may also be added to the air elsewhere in the intake system by means of injectors or other fuel delivery mechanisms such as carburetors.

The cylinder may also be fitted with sensors to measure engine parameters such as pressure, temperature, ionization, and flame radiation. Such a sensor may be a freestanding transducer 24, a combination transducer combining two or more sensors, or, one that is incorporated with other components such as the spark plug. Also shown in FIG. 1 are the top center (TC) position 25 and the bottom center (BC) position 26 of the piston which are the positions during a cycle where the piston face is closest and furthest away from the cylinder head respectively.

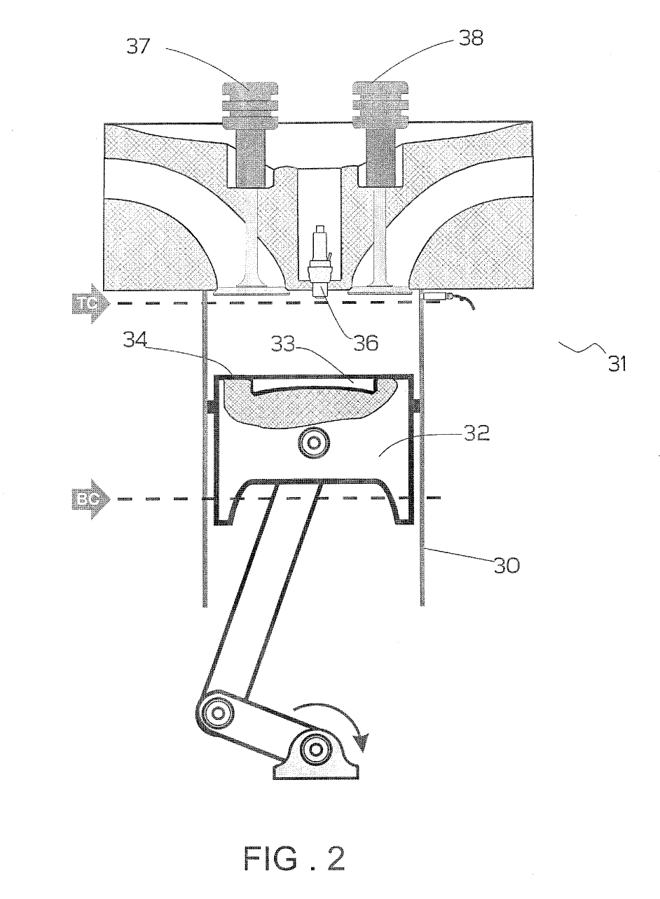

FIG. 2, a schematic of another embodiment of the invention, shows a cylinder 30 of an injection engine 31, such as a CI engine. Slidably fitted within the cylinder is piston 32 (shown as partially sectioned) with a cupped portion 33 and squish area 34 on the surface of the piston that faces the cylinder head. The difference in the spacing between the cylinder head and the cupped and the squish areas of the piston can be used to generate high in-cylinder velocities, whenever the piston approaches the cylinder-head.

The cylinder-head is also fitted with a fuel injector 36 for injection of fuel into the cylinder. CI engines may also have glow-plugs (not shown) that can be used to assist in starting an engine during cold temperatures. FIG. 2 also shows actuators 37 and 38 that may be used to control the opening and or closing of the intake and exhaust valves and the amounts of their lifts respectively with flexible timing. A ISI engine may be similarly configured to the embodiment in FIG. 2, although a spark plug or other igniters may need to be incorporated.

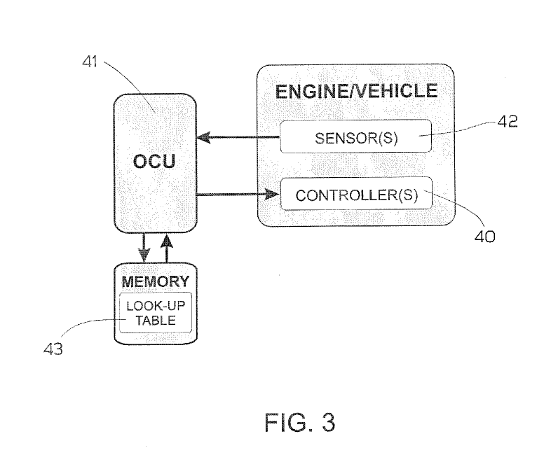

In IC engines built according to the invention, the intake and exhaust valves may be opened and closed at various times during the cycle. The valve actuators/controllers 40 (in FIG. 3) may be used to open the valves as commanded by at least one onboard control unit (OCU) 41. It is preferred that this controller operate based on input from one or more sensors 42 that measure various engine and ambient parameters. The OCU may also operate the valve actuators based on look up tables 43 that are a function of engine operating conditions in an open loop fashion or in conjunction with input from one or more sensors. This information collected from sensors or look-up tables could be used to compute, for example, mass fraction burned in the cylinder, the likelihood of having liquid fuel in the cylinder at a given point in the cycle, the amount of oxygen remaining in the cylinder, and the temperature of the mixture in the cylinder.

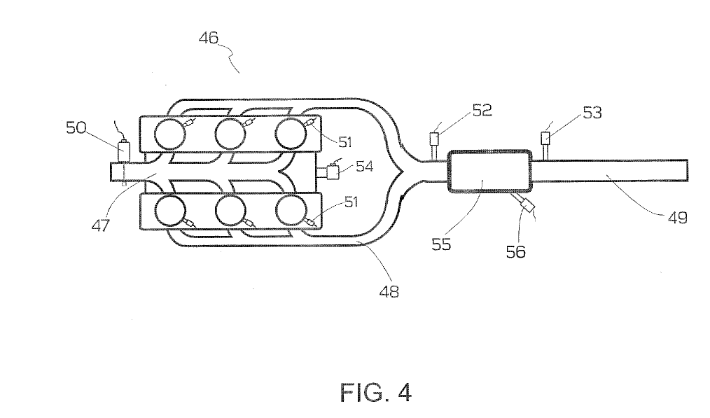

FIG. 4 shows a six cylinder IC engine 46 with an intake manifold 47, exhaust manifold 48, and tail pipe 49. Various sensors that may be used in implementing the invention including intake manifold sensors 50 such as mass air flow detector, temperature and pressure transducers; in-cylinder transducers 51 such as pressure, temperature, ionization sensors, and gas composition and flame detectors; exhaust manifold sensors 52 and tail pipe sensors 53, such as temperature transducers, gas flow sensors and oxygen concentration detectors; and an output shaft sensor 54 such as position, angular acceleration and torque detectors.

Also shown in FIG. 4 is an IC engine exhaust gas emission control device 55 such as a TWC commonly used with most SI engines, particulate trap, or a NOx trap that can be used with CI engines. The exhaust gas emission control device may also be fitted with sensors 56 to measure quantities such as oxygen concentration and temperature.

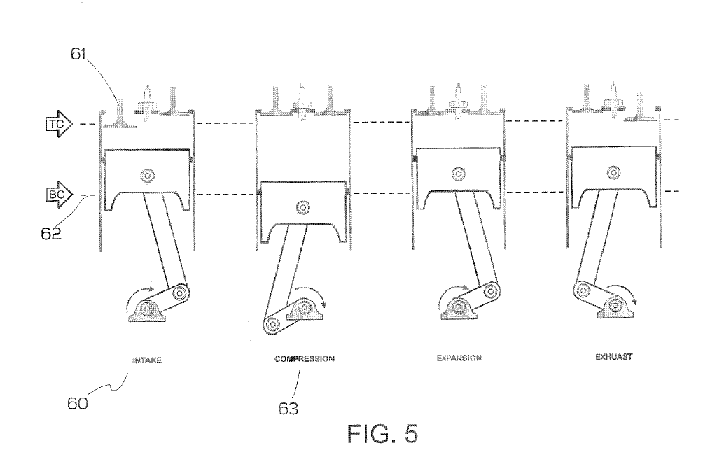

FIG. 5 shows a cylinder of a SI engine undergoing a conventional 4-stroke cycle comprising an intake stroke 60, where at least one intake valve 61 is open to allow mass to flow into the cylinder due to the suction resulting from the motion of the piston. The mass entering the cylinder is typically an air-fuel mixture which may also include EGR. When the piston reaches the BC position 62, the piston reverses direction, the intake valve closes and the compression stroke 63 begins. As the piston approaches the TC position 64, typically a spark plug or other ignition device is used to ignite the mixture. Ignition may also occur by other processes such as HCCI.

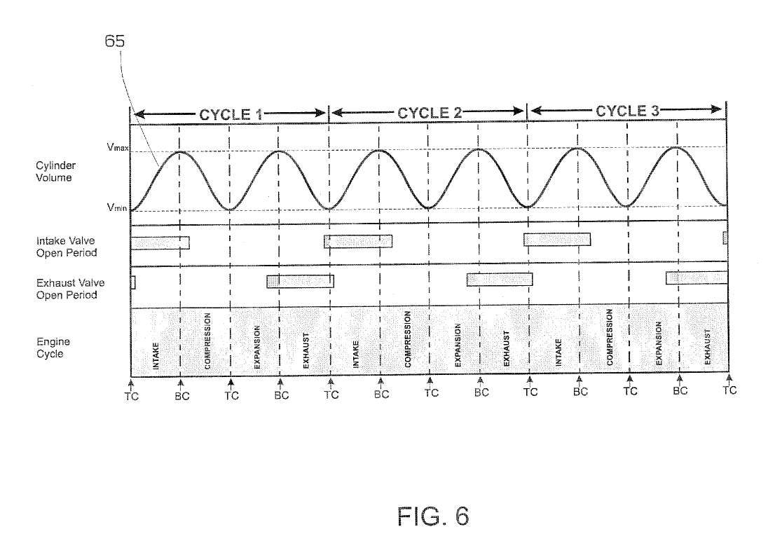

FIG. 6 shows valve timing diagram for three cycles of an engine such as that shown in FIG. 5. Also shown is the variation in the volume of the cylinder 65. The horizontal axis in this figure represents time or crank angle position during the cycle. Noted are the times when the piston is at the TC or BC position. The intake and exhaust valve open periods are examples of valve timing when the engine cylinder, such as that shown in FIG. 5, is operated with conventional timing. With such timing, intake valves typically start opening slightly before the start of the intake stroke and close slightly after its end. Similarly, the exhaust valves typically open shortly before the start of the exhaust stroke and close slightly after its end.

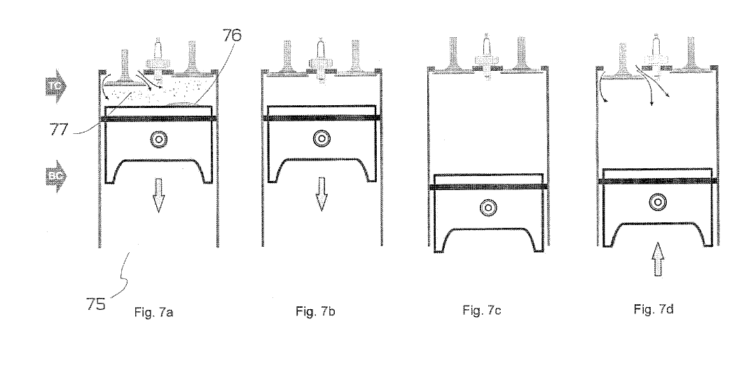

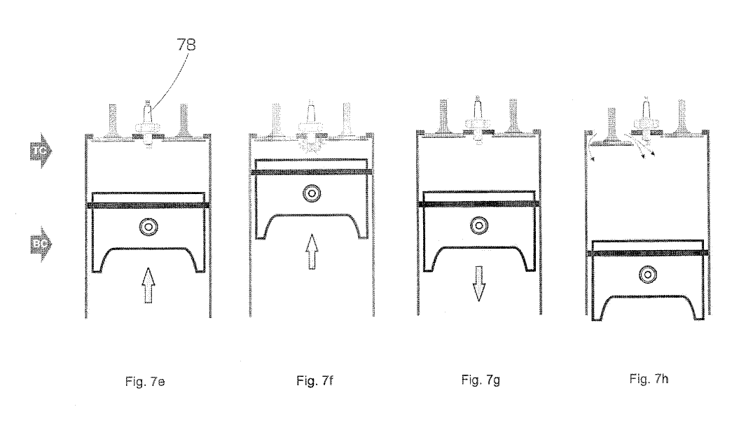

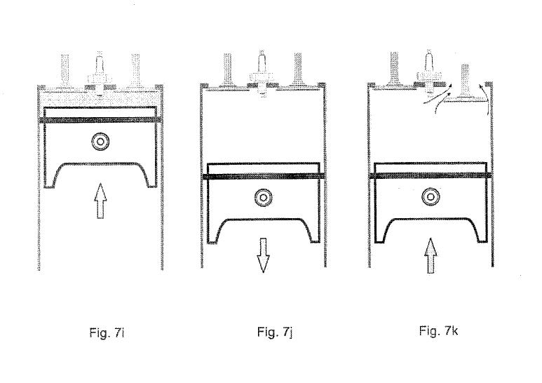

FIGS. 7a-7k represent an SI engine cylinder operating according to one embodiment of the invention using a liquid fuel. During the intake process 75, the motion of the piston causes mass of air and fuel to enter the cylinder. Under certain circumstances, EGR may be added to the air before it enters the cylinder. Some of the fuel has not evaporated and is in the form of puddles 76 or droplets 77. During the intake process, the intake valve is closed before the piston reaches the BC position so that the further motion of the piston causes the formation of a vacuum in the cylinder (FIG. 7c). The lowered pressure in the cylinder induces bubbles to form in the liquid fuel which accelerate its breakup and evaporation.

An intake valve may reopen (FIG. 7d) when the piston is at or near the BC position if the pressure in the cylinder is sufficiently lower than the pressure upstream of the intake valve and if additional mass is desired. This additional mass may be comprised of air or air and fuel and may also include EGR. In FIG. 7e, the intake valve has again closed and the piston continues to compress the mixture in the cylinder until it is ignited by the ignition device 78. The ignition device is preferably a spark plug, although other devices such as plasma igniters may be used. The charge may also be ignited by other processes such as HCCI. If the mixture is successfully ignited (FIG. 7f) and burned, the pressure and temperature in the cylinder will rise and, as the piston moves (FIG. 7g), it will transfer power to the engine output shaft (not shown). If the mixture is not ignited and burned properly because of slow evaporation or chemical reactions, the resulting pressure and temperature will be lower.

If the piston is again at a point where the pressure in the cylinder is sufficiently lower than the pressure upstream of the intake valve, the intake valve may again be opened to admit additional air or fuel-air mixture into the cylinder (FIG. 7h). Additional compression and ignition events (FIG. 7i) and expansion (FIG. 7j) may be utilized to allow sufficient time for physical and chemical process to proceed to a desired degree of completion. Once a desired level of charge combustion is achieved, an exhaust process (FIG. 7k) is utilized to empty the cylinder and prepare for the start of a new cycle.

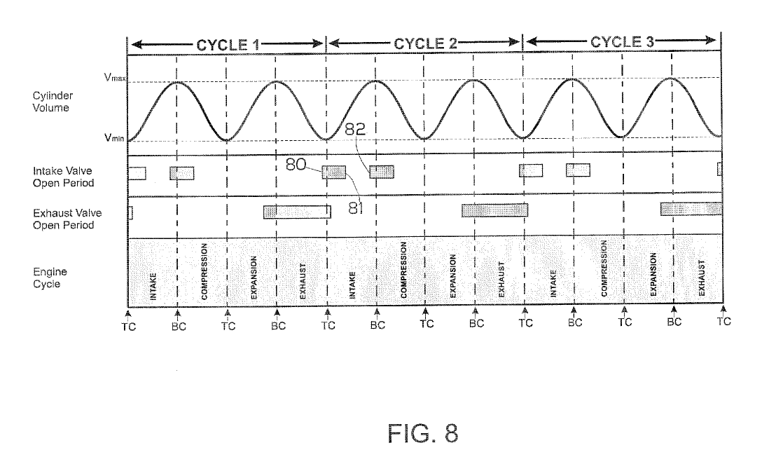

FIG. 8 shows the valve timing diagram of an embodiment of an SI engine according to the invention. The intake valve is opened late in the exhaust process 80 and closed during the intake process 81 such that a certain amount of air and fuel is inducted into the cylinder. The intake valve is then reopened either late in the intake process 82 or early during the compression process. During the portion of the intake process where the intake valve is closed, the expansion in the volume due to the motion of the piston will cause the pressure in the cylinder to drop. The lower pressure will aid in the break up and evaporation of liquid fuel in the cylinder. To achieve lowered cylinder pressure during the intake process, the intake valve does not have to be fully closed between 81 and 82, but may be kept partially open. In the embodiment represented by FIG. 8, the cycle remains a 4 stroke cycle as in the conventional arrangement in FIG. 6.

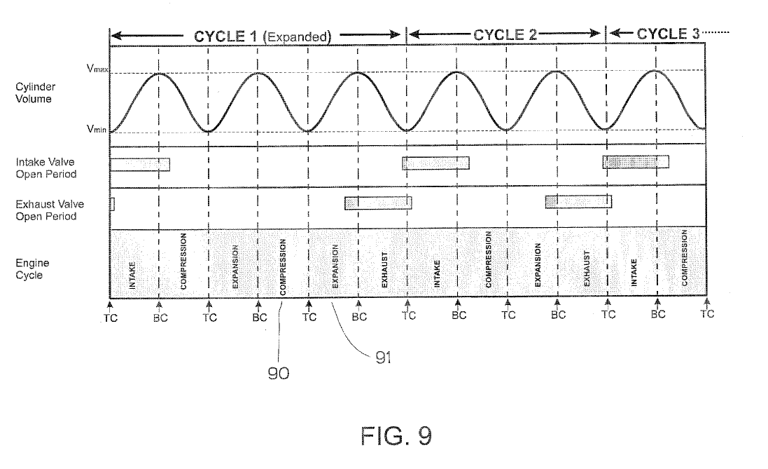

FIG. 9 shows the valve timing diagram for a further embodiment of an SI engine according to the invention. In this embodiment, the intake valves are operated such that air or a fuel and air mixture is inducted into the cylinder. But, the conventional 4-stroke cycle timing of one of the cycles is expanded to include an additional compression 90 and expansion 91 strokes. This increases the time available for in-cylinder physical and chemical processes such as evaporation, ignition and combustion. Near the end of each compression stroke in this 6-stroke cycle, the mixture may be ignited by means of a spark device, such as a spark plug, or by means of other processes such as HCCI. In the case of ISI engines, fuel may be added to the cylinder at one or more points during the cycle.

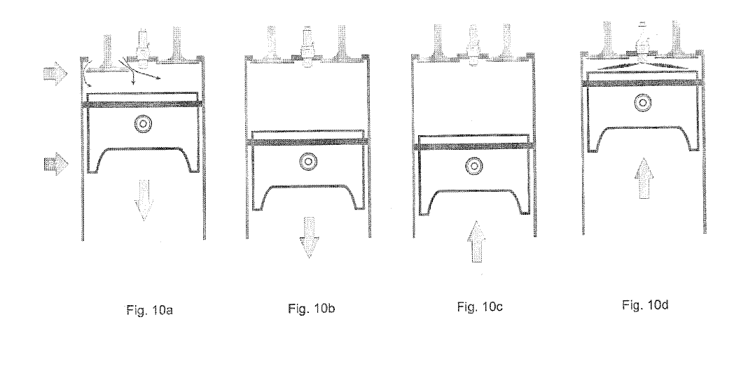

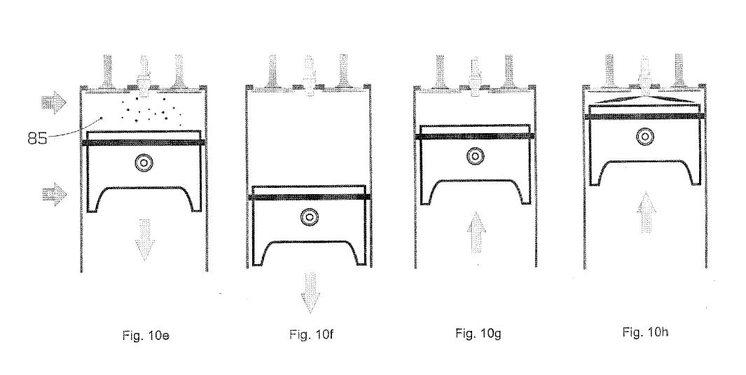

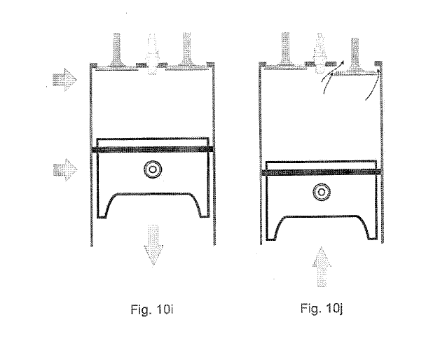

FIGS. 10a-10j shows a cylinder of a CI engine undergoing an expanded cycle. FIG. 10a shows the intake process where air or air with added EGR is inducted into the cylinder. In some CI engines, some fuel may already have been added to the intake stream before it enters the cylinder. The intake valve may be closed during the intake process so that the motion of the piston causes the pressure in the cylinder to be low whenever the volume approaches its maximum value. In FIG. 10c, the gases in the cylinder are being compressed because of the motion of the piston. Late in the compression process (FIG. 10d) or shortly thereafter, fuel may be injected into the cylinder. The injected fuel may evaporate and, for example, ignite as a result of auto-ignition. Under conditions where the engine is cold, such as cold-start, evaporation may be so slow such that liquid fuel 85 may survive into the expansion process (FIG. 10e). When the piston moves towards its BC position, the pressure may again drop to a low level which will facilitate the break up of any liquid fuel through bubble formation (FIG. 10f). Near the end of the expansion stroke, the intake valve may be reopened (not shown) if the pressure difference across the intake valve is such that mass will flow into the cylinder and additional mass flow is desired.

FIGS. 10g-h show the cylinder undergoing an additional compression. Fuel may again be injected and allowed to burn in a diffusion flame as a result of auto-ignition. Combustion may also be initiated or assisted by a positive ignition source such as a spark plug (not shown). FIG. 10i shows the cylinder undergoing an additional expansion process and FIG. 10j shows an exhaust process.

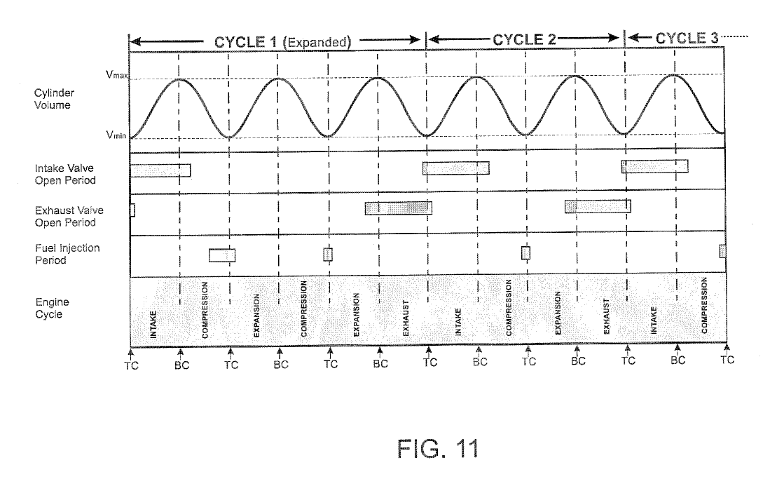

FIG. 11 shows the valve and injection timing of an IC engine with in-cylinder injection operating according to the invention. The valve timing is such that the conventional 4-stroke cycle is expanded to include additional compression and expansion strokes. The engine may be switched to the expanded cycle for only special operating conditions, while conventional 4-stroke cycles are used during normal operation. Such expanded cycles may be used during cold start or where elevated exhaust temperature is needed, for example, to regenerate a particulate trap.

In FIG. 11 fuel is injected during the first compression stroke. The fuel injection periods in FIG. 11 may comprise a single injection pulse or multiple pulses. At the end of the compression, the fuel is ignited by, for example, autoignition, a spark plug or HCCI. Positive ignition sources such as spark plugs may be used to augment ignition or serve as the primary mode of ignition. Additional fuel may also be injected late in the second compression stroke and allowed to ignite, for example, by autoignition and burn in a diffusion flame as in a conventional CI engine.

In operating an engine according to this invention, at least one valve of at least one cylinder of an engine must be controllable, such that the time of opening or closing may be flexibly controlled with respect to the position of the piston, preferably as a result of an electrical signal. Flexibly controllable valves allow intake and exhaust processes to occur independently of each others at different times during the cycle and be of variable duration or lift. Fuel may be added to the air at any point upstream of a cylinder's intake valve or injected into the cylinder or a combination of the two methods. The fuel-air mixture in the combustion chamber may be ignited for example by an electric discharge device such as a spark plug, by non-homogeneous auto ignition such as in a diesel engine or by HCCI or by a combination of these methods.

The invention has been described in terms of its functional principles and several illustrative embodiments. Many variants of such embodiments will be obvious to those skilled in the art. Therefore, it should be understood that the ensuing claims are intended to cover all changes and modifications of the illustrative embodiments that fall within the literal scope of the claims and all equivalents thereof.

1. An internal combustion engine modified to reduce the fraction of unburned and partially burned air/fuel mixture exhausted during the cold start period, which comprises:
a. at least one cylinder having a combustion chamber, a slidable piston, and at least one intake valve and at least one exhaust valve,
h. means for forming a combustible air/fuel mixture in the combustion chamber.
c. means for igniting said mixture in the combustion chamber
d. means for extending the time available for combustion of said mixture during said cold start period

2. The engine according to claim 1 wherein said means for extending time includes means for increasing the number of strokes in the engine cycle during said cold start period.

3. The engine according to claim 2 wherein means for increasing includes means for maintaining said valves in a closed position until said additional strokes have occurred

4. The engine according to claim 2 wherein means for extending includes means for determining the degree to which said mixture in said cylinder has be burned.

5. The engine according to claim 4 wherein means for detecting includes a cylinder pressure sensor.

6. The engine according to claim 4 wherein means for detecting includes a sensor for measuring the temperature of the gases in the cylinder.

7. The engine according to claim 4 wherein means for detecting includes a sensor for- measuring instantaneous engine torque.

8. The engine according to claim 4 wherein means for detecting includes a sensor for measuring instantaneous engine shaft speed.

9. A method of modifying an internal combustion engine to reduce the fraction of unburned and partially burned air/fuel mixture exhausted during the cold start period, which comprises:
a. providing at least one cylinder having a combustion chamber, a slidable piston and at least one intake valve and at least one exhaust valve,
b. forming a combustible air/fuel mixture in the combustion chamber,
c. igniting the mixture in the combustion chamber, and
d. extending the time available for combustion of said mixture during said cold start period.

10. A method according to claim 9 which includes increasing the number of strokes in the engine cycle during said cold start period.

11. A method according to claim 10 which includes maintaining said valves in a closed position until said additional strokes have occurred.

12. A method according to claim 10 which includes determining the degree to which said mixture in said cylinder has been burned.

13. A method according to claim 12 which includes detecting the degree to which said mixture has burned by sensing the pressure in the cylinder.

14. A method according to claim 12 which includes detecting the degree to which mixture has burned by measuring the temperature of the gases in the cylinder.

15. A method according to claim 12 which includes detecting the degree to which said mixture has burned by measuring the instantaneous torque of the engine.

16. A method according to claim 12 which includes detecting the degree to which said mixture has burned by measuring the instantaneous speed of the engine shaft.
